(19) United States
(12) Patent Application Publication
(10) Pub. No.: US 2025/0232758 A1
(43) Pub. Date: Jul. 17, 2025

(54) MACHINE-LEARNING-BASED NETWORKING GRAPHICAL USER INTERFACE

(71) Applicant: PwC Product Sales LLC, New York, NY (US)

(72) Inventors: Garima GUPTA, Pune (IN); Vaibhav SHAH, Pune (IN); Deepa IYER, San Francisco, CA (US); Ian KAHN, Massapequa, NY (US); Jordan KUNZ, Arlington, VA (US); Sindhu ZACHARIAH, Evergreen, CO (US); Kristin MEYER, Austin, TX (US)

(73) Assignee: PwC Product Sales LLC, New York, NY (US)

(21) Appl. No.: 18/413,999

(22) Filed: Jan. 16, 2024

(51) Int. Cl. G10L 13/02; G06F 40/20; G10L 13/08

(52) U.S. Cl. CPC G10L 13/02; G06F 40/20; G10L 13/08

(57) ABSTRACT

A method for displaying a graphical user interface (GUI) for facilitating interactions with one or more entities may include receiving data associated with the one or more entities from one or more data sources, providing the data associated with the one or more entities to one or more machine learning models, receiving explainability data from the one or more machine learning models, wherein the explainability data indicates one or more recommendations for interacting with the one or more entities, and displaying the GUI for facilitating interactions with the one or more entities, wherein the GUI comprises one or more communication affordances generated using the explainability data, wherein a user selection of a communication affordance generates a communication data structure configured to facilitate a recommended interaction of the one or more recommended interactions via a communication medium.

### FIELD

The present disclosure relates to graphical user interfaces (GUIs) for networking and communication.

### BACKGROUND

The creation and maintenance of connections is frequently critical to a person's professional success. However, the success of a given interaction depends strongly upon the initiating party's ability to identify and pursue fruitful interaction opportunities. In many cases, potential interaction opportunities may be overlooked due to a lack of awareness of relevant information or a lack of ability to properly or efficiently assess relevant information.

### SUMMARY

Disclosed are techniques for generating a graphical user interface (GUI) for facilitating interactions between a user and one or more entities. Data about both the user and the entities may be provided to trained machine learning models, which may identify opportunities for the user to connect with each of the entities. The GUI may display explanations of each identified opportunity for the user along with selectable communication affordances that, when selected, generate data structures (e.g., draft emails or meeting scripts) that can help the user to initiate communication with an entity about an identified opportunity. After pursuing an identified opportunity, the user may input feedback about the success of their interactions using the GUI to improve future interaction recommendations.

The provided techniques may leverage machine learning methods in various ways. Supervised and unsupervised learning models can be used to preprocess and organize data that is ingested about the entities. For example, supervised and unsupervised learning models may be used to classify ingested entity data according to predefined interaction scenarios. The classified entity data may be used to generate prompts for large language models that cause the large language models to output descriptions of opportunities for a user to interact with one or more entities. Users may interact with the large langue models in real time to, e.g., update the data structures that are intended to help the user initiate an interaction with an entity. Reinforcement learning models can be used to update inputs to or parameters of other machine learning models based on feedback provided by the user.

A method for displaying a graphical user interface (GUI) for facilitating interactions with one or more entities can comprise receiving data associated with the one or more entities from one or more data sources, providing the data associated with the one or more entities to one or more machine learning models, receiving explainability data from the one or more machine learning models, wherein the explainability data indicates one or more recommendations for interacting with the one or more entities, and displaying the GUI for facilitating interactions with the one or more entities, wherein the GUI comprises one or more communication affordances generated using the explainability data, wherein a user selection of a communication affordance generates a communication data structure configured to facilitate a recommended interaction of the one or more recommended interactions via a communication medium.

The one or more data sources may include a server storing historical interaction data associated with at least one of the one or more entities and/or one or more news reports about at least one of the one or more entities. Providing the data associated with the one or more entities to the one or more machine learning models may include categorizing the data associated with the one or more entities according to one or more predefined interaction scenarios using a first machine learning model and generating one or more prompts for a large language model based on categorization of the data associated with the one or more entities. The one or more prompts may be configured to cause the large language model to output the explainability data.

The method can further comprise receiving a user selection of a communication affordance of the one or more communication affordances. In some embodiments, the communication medium associated with the selected communication affordance is email. The method may involve generating a communication data structure comprising an email to be sent to a representative of the entity associated with the selected communication affordance in response to the user selection of the communication affordance and sending the email to the representative of the entity associated with the selected communication affordance. In other embodiments, the communication medium associated with the selected communication affordance is a video or voice call application or a phone network and, in response to the user selection of the communication affordance, a communication data structure comprising a script for a call with a representative of the entity associated with the selected communication affordance may be generated. The representative of the entity associated with the selected communication affordance may be contacted using the video or voice call application or the phone network. The script for the call may be displayed on the GUI while the call is in progress. The script may also be provided to a text-to-speech application to generate audio data comprising the script, and the audio data to the representative of the entity while the call is in progress. Additionally or alternatively, in response to the user selection of the communication affordance, a communication data structure comprising an invitation for a call with a representative of the entity associated with the selected communication affordance may be generated, and an electronic calendar associated with the representative of the entity with the invitation may be populated.

User feedback associated with a communication affordance of the one or more communication affordances may be received. The user feedback may indicate an outcome of interacting with an entity of the one or more entities according to the recommended interaction associated with the communication affordance. The method may include providing the user feedback to a reinforcement learning model and receiving updated explainability data indicating an improved recommendation for interacting with the entity.

A system for displaying a graphical user interface for facilitating interactions with one or more entities may comprise one or more processors configured to receive data associated with the one or more entities from one or more data sources, provide the data associated with the one or more entities to one or more machine learning models, receive explainability data from the one or more machine learning models, wherein the explainability data indicates one or more recommendations for interacting with at least one of the one or more entities, and display the GUI for facilitating interactions with the one or more entities, wherein the GUI comprises one or more communication affordances generated using the explainability data, wherein a user selection of a communication affordance generates a communication data structure configured to facilitate a recommended interaction of the one or more recommended interactions via a communication medium.

A non-transitory computer readable storage medium may comprise instructions for displaying a graphical user interface for facilitating interactions with one or more entities that, when executed by one or more processors of a computer system, cause the computer system to receive data associated with the one or more entities from one or more data sources, provide the data associated with the one or more entities to one or more machine learning models, receive explainability data from the one or more machine learning models, wherein the explainability data indicates one or more recommendations for interacting with at least one of the one or more entities, and display the GUI for facilitating interactions with the one or more entities, wherein the GUI comprises one or more communication affordances generated using the explainability data, wherein a user selection of a communication affordance generates a communication data structure configured to facilitate a recommended interaction of the one or more recommended interactions via a communication medium.

### BRIEF DESCRIPTION OF THE FIGURES

The following figures show various systems, methods, apparatuses, and graphical user interfaces (GUIs) for facilitating interactions with one or more entities. The systems, methods, apparatuses, and GUIs shown in the figures may have any one or more of the characteristics described herein.

FIG. 1 shows a system for displaying a GUI for facilitating interactions with one or more entities, according to some embodiments.

FIG. 2 shows a computer system, according to some embodiments.

FIG. 3 shows a method for displaying a GUI for facilitating interactions with one or more entities, according to some embodiments.

FIG. 4A shows a diagram of a GUI for facilitating interactions with one or more entities, according to some embodiments.

FIG. 4B shows a diagram of a GUI for facilitating interactions with one or more entities when a user selects a first communication affordance, according to some embodiments.

FIG. 4C shows a diagram of a large language model chatbot that may be provided by a GUI for facilitating interactions with one or more entities to allow the user to make changes to a communication data structure, according to some embodiments.

FIG. 4D shows a diagram of a GUI for facilitating interactions with one or more entities when a user selects a second communication affordance, according to some embodiments.

FIG. 4E shows a diagram of a GUI for facilitating interactions with one or more entities when a user selects a third communication affordance, according to some embodiments.

FIG. 4F shows the top-left portion of an example GUI for facilitating interactions with one or more entities.

FIG. 4G shows the bottom-left portion of an example GUI for facilitating interactions with one or more entities.

FIG. 4H shows the top-right portion of an example GUI for facilitating interactions with one or more entities.

FIG. 4I shows the bottom-left portion of an example GUI for facilitating interactions with one or more entities.

FIG. 5 shows a system of machine learning models for that may be leveraged by a system for displaying a GUI for facilitating interactions with one or more entities, according to some embodiments.

### DETAILED DESCRIPTION

Disclosed are systems, methods, apparatuses, and non-transitory computer readable storage media for generating a graphical user interface (GUI) for facilitating interactions between a user and one or more entities. Data about both the user and the entities may be provided to trained machine learning models, which may identify opportunities for the user to connect with each of the entities. The GUI may display explanations of each identified opportunity for the user along with selectable communication affordances that, when selected, generate data structures (e.g., draft emails or meeting scripts) that can help the user to initiate communication with an entity about an identified opportunity. After pursuing an identified opportunity, the user may input feedback about the success of their interactions using the GUI to improve future interaction recommendations.

The provided systems, methods, apparatuses, and non-transitory computer readable storage media may leverage machine learning methods in various ways. Supervised and unsupervised learning models can be used to preprocess and organize data that is ingested about the entities. For example, supervised and unsupervised learning models may be used to classify ingested entity data according to predefined interaction scenarios. The classified entity data may be used to generate prompts for large language models that cause the large language models to output descriptions of opportunities for a user to interact with one or more entities. Users may interact with the large langue models in real time to, e.g., update the data structures that are intended to help the user initiate an interaction with an entity. Reinforcement learning models can be used to update inputs to or parameters of other machine learning models based on feedback provided by the user.

The following description sets forth exemplary methods, parameters, and the like. It should be recognized, however, that such description is not intended as a limitation on the scope of the present disclosure but is instead provided as a description of exemplary embodiments.

Although the following description uses terms “first,” “second,” etc. to describe various elements, these elements should not be limited by the terms. These terms are only used to distinguish one element from another. For example, a first graphical representation could be termed a second graphical representation, and, similarly, a second graphical representation could be termed a first graphical representation, without departing from the scope of the various described embodiments. The first graphical representation and the second graphical representation are both graphical representations, but they are not the same graphical representation.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

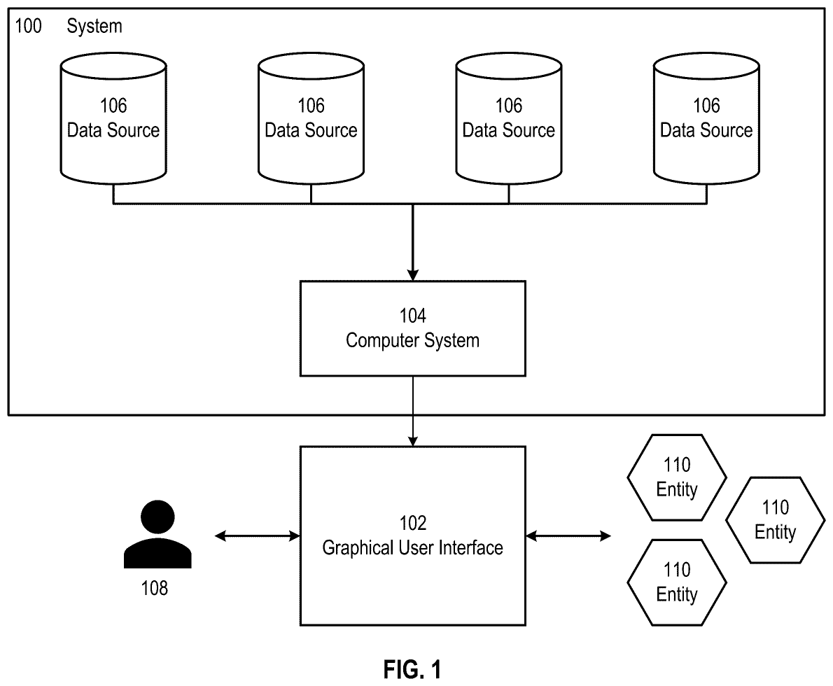

FIG. 1 shows an exemplary system 100 for generating and displaying a graphical user interface (GUI) 102 for facilitating interactions between a user 108 and one or more entities 110. System 100 may include a computer system 104 as well as one or more data sources 106. Computer system 104 may provide data from data sources 106 to a set of machine learning models. Based on the provided data, the machine learning models may recommend that user 108 interact with one or more of the entities 110. Computer system 104 may display explanations of these recommendations to user 108 on GUI 102 along with user-selectable communication affordances for assisting user 108 in initiating the recommended interactions.

User 108 may be any person, group of people, or entity (e.g., corporation, university, etc.) who wishes to make and maintain data-informed connections with entities 110. For example, user 108 may be a salesperson or an attorney and entities 110 may be existing or potential clients of user 108. User 108 can also be a recruiter, for instance a job recruiter for a corporation or a student recruiter for a college or university, in which case entities 110 may be potential candidates for jobs at the corporation or potential applicants to the college or university. In other embodiments, user 108 is a fundraiser (e.g., for a political campaign or a non-profit organization) and entities 110 are potential donors.

The success of a given interaction between user 108 and an entity 110 may depend on numerous social, political, environmental, and economic factors. If user 108 were to contact entity 110 without proper awareness of these factors and their potential effects on entity 110, the interaction between user 108 and entity 110 may be unproductive or unprofitable. However, gaining sufficient insight into the factors currently affecting an entity 110 may require user 108 to find, view, and process large amounts of data associated with said entity. Such work may be time-consuming and cost-inefficient, particularly if user 108 is attempting to maintain connections with multiple entities simultaneously.

The recommendations for interacting with entities 110 provided to user 108 by system 100 via GUI 102 may account for a myriad of social, political, environmental, and economic factors that may influence the outcomes of interactions between user 108 and entities 110 without requiring that user 108 personally identify and analyze data associated with entities 110. Rather, as described above, computer system 104 may ingest data associated with entities 110 from data sources 106.

The data associated with a given entity may characterize a state of that entity at the time the data is received. For example, the data associated with a given entity may characterize the entity's recent financial performance or the entity's social standing (e.g., the level of approval or disapproval that the entity's customers express toward the entity). The data associated with a given entity can also indicate recent political, social, economic, or environmental events that may impact the entity. Data sources 106 may include any suitable resources that provide information any of entities 110, including (but not limited to) news outlets, financial data sources, governmental data sources, academic data sources, surveys, and customer reviews. In some embodiments, a data source 106 that provides data about an entity 110 may be the entity itself.

Data sources 106 can vary depending on user 108's role. If, for example, user 108 is a salesperson, data sources 106 may include servers, databases, or data stores associated with customer relationship management software and applications such as those provided by Salesforce, Inc. These applications may collect, e.g., data about products or services that each entity 110 has purchased from user 108. This data may include information about the timing of each sale (e.g., the date of each sale), the products and/or services that were purchased during each sale, and the profit earned from each sale. The customer relationship management software and applications may also gather data about user 108, for instance data about user 108's profit goals for a given time span (e.g., for a given fiscal year).

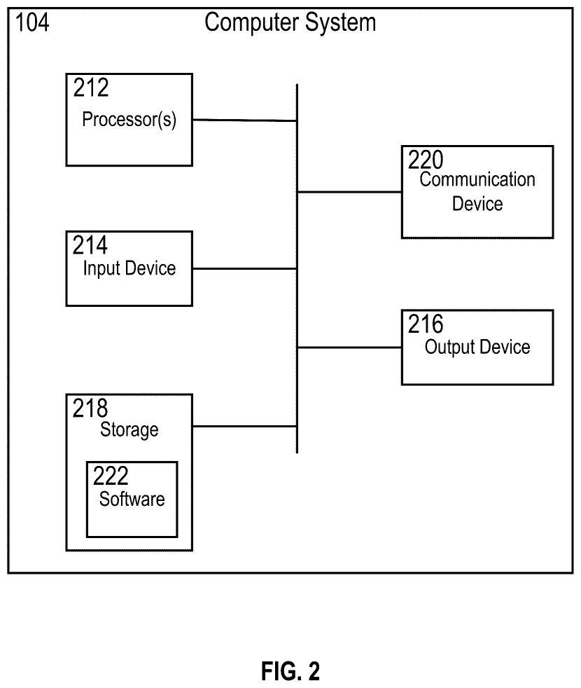

Computer system 104 can be any suitable type of microprocessor-based device, such as a personal computer belonging to user 108, a workstation belonging to user 108, a server, a handheld computing device (e.g., a portable electronic device) such as a phone or a tablet, or a dedicated device. An exemplary block diagram of computer system 104 is provided in FIG. 2. As shown, computer system 104 may include one or more processors 212, an input device 214, an output device 216, storage 218, and a communication device 220.

Input device 214 and output device 216 can be connectable or integrated with system 104. Input device 214 may be any suitable device that provides input, such as a touch screen, keyboard or keypad, mouse, or voice-recognition device. Likewise, output device 216 can be any suitable device that provides output, such as a display, touch screen, haptics device, or speaker. In some embodiments, GUI 102 is displayed to user 108 using output device 216.

Storage 218 can be any suitable device that provides (classical) storage, such as an electrical, magnetic, or optical memory, including a RAM, cache, hard drive, removable storage disk, or other non-transitory computer readable medium. Communication device 220 can include any suitable device capable of transmitting and receiving signals over a network, such as a network interface chip or device. The components of computer system 104 can be connected in any suitable manner, such as via a physical bus or via a wireless network.

Processor(s) 212 may be or comprise any suitable processor or combination of processors, including any of, or any combination of, a central processing unit (CPU), a field programmable gate array (FPGA), and an application-specific integrated circuit (ASIC). Software 222, which can be stored in storage 218 and executed by processor(s) 212, can include, for example, the programming that embodies the functionality of the present disclosure. Software 222 may be stored and/or transported within any non-transitory computer-readable storage medium for use by or in connection with an instruction execution system, apparatus, or device that can fetch instructions associated with the software from the instruction execution system, apparatus, or device and execute the instructions. In the context of this disclosure, a computer-readable storage medium can be any medium, such as storage 218, that can contain or store programming for use by or in connection with an instruction execution system, apparatus, or device.

Software 222 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Computer system 104 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer system 104 can implement any operating system suitable for operating on the network. Software 222 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

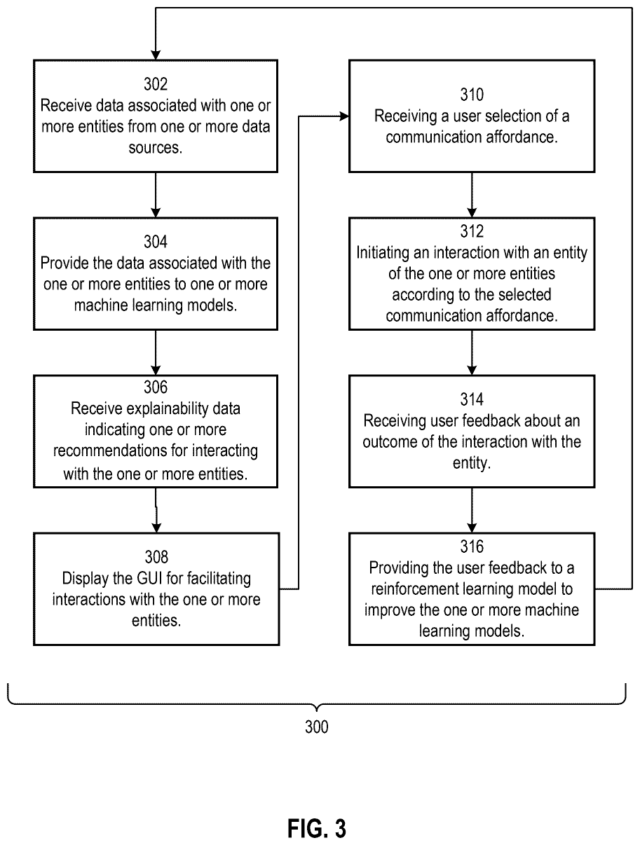

FIG. 3 provides an exemplary method 300 for displaying a GUI for facilitating interactions with one or more entities. Method 300 may be executed by computer system (e.g., computer system 104) in a system (e.g., system 100) for generating and displaying a graphical user interface (GUI) for facilitating interactions between a user and one or more entities (e.g., GUI 102). In some embodiments, method 300 is performed automatically by the computer system, for instance according to a predefined schedule or in response to receiving certain data (e.g., data associated with the one or more entities). In other embodiments, method 300 is performed upon receipt of a suitable command from the user.

As shown, method 300 may begin with a step 302, wherein the computer system may receive data associated with one or more entities from one or more data sources. The data may provide information pertaining to the state (e.g., financial performance, social approval, etc.) of each entity, for example information about recent social, political, economic, or environmental events that may impact or have impacted each entity. At least a portion of the data associated with the one or more entities is received from a server or data store that stores data about previous interactions between a user of the computer system (e.g., user 108 shown in FIG. 1) and each entity of the one or more entities. If the user is, for example, a salesperson, then this server or data store may be associated with a customer relationship management application such as a Salesforce application.

After the data associated with the one or more entities is received, the data may be provided to one or more machine learning models (step 304). Subsequently, explainability data indicating one or more recommendations for interacting with the one or more entities may be received from the one or more machine learning models (step 306). For each recommended interaction, the explainability data may include data indicating how the one or more machine learning models determined that the interaction should be recommended to the user. For example, the explainability data may comprise data structures linking each recommended interaction to portions of the data received from the one or more data sources in step 302 that justify or provide evidence for the recommended interaction. The GUI for facilitating interactions with the one or more entities may then be displayed (step 308).

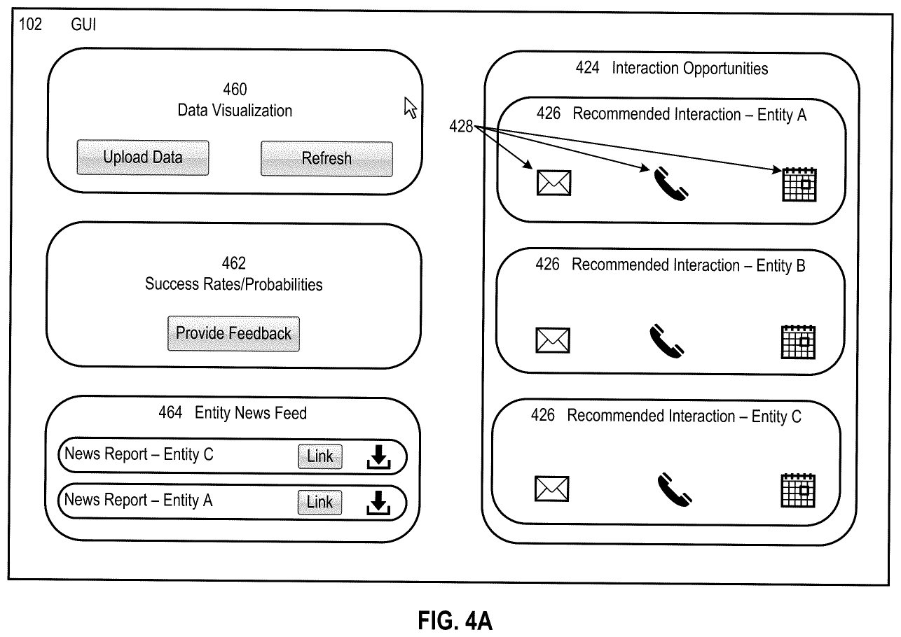

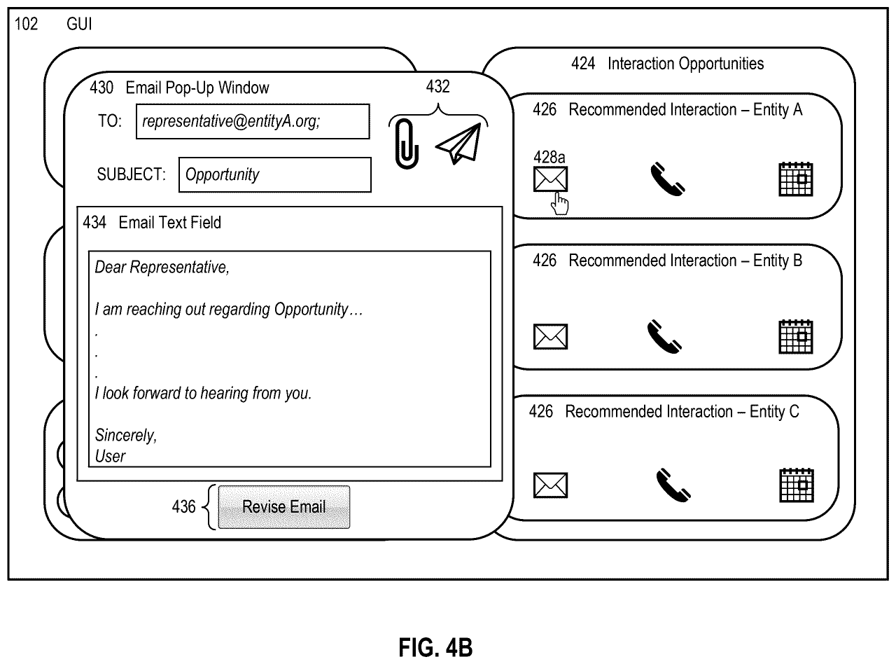

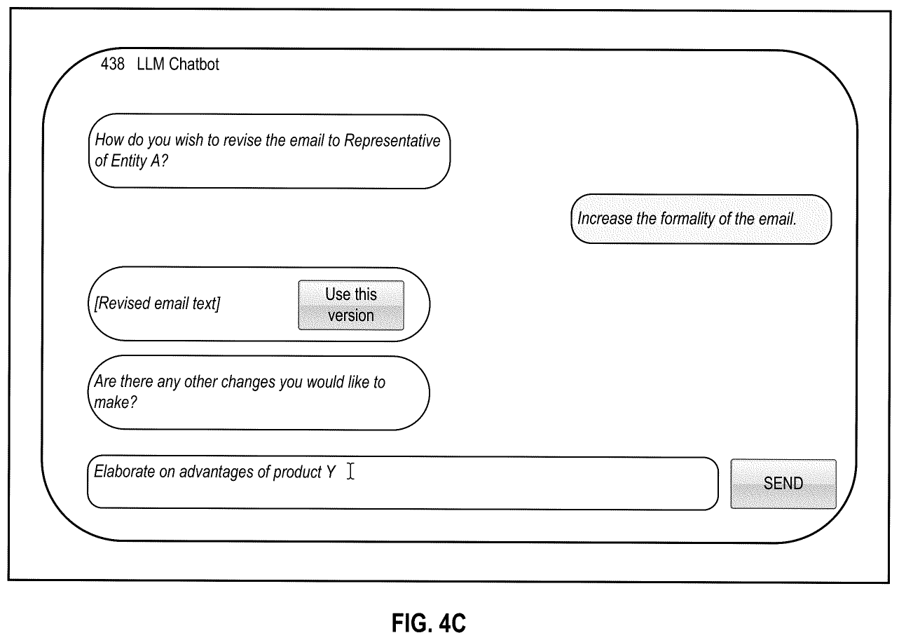

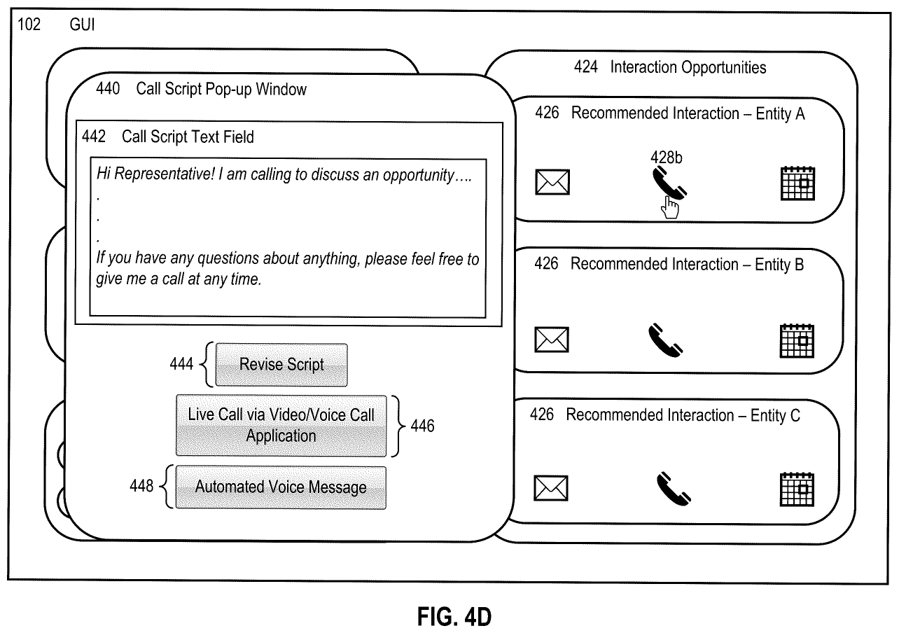

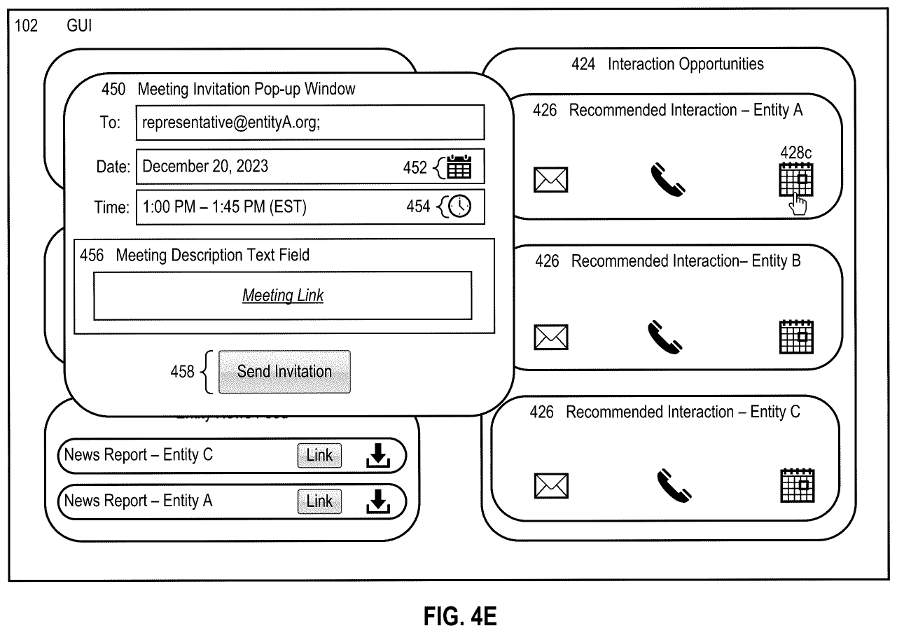

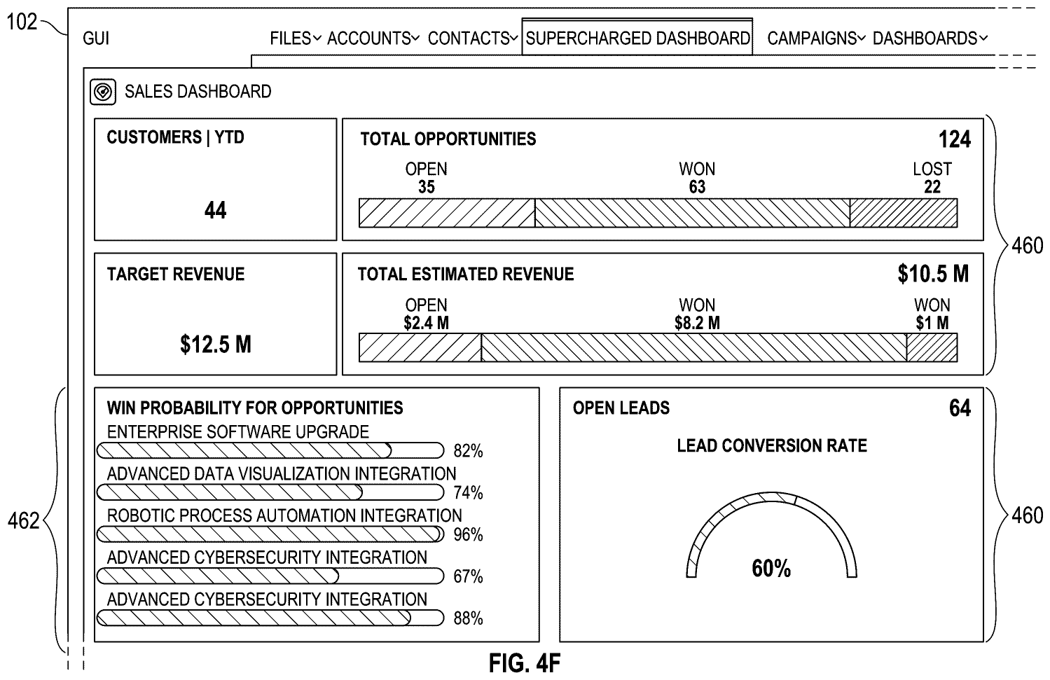

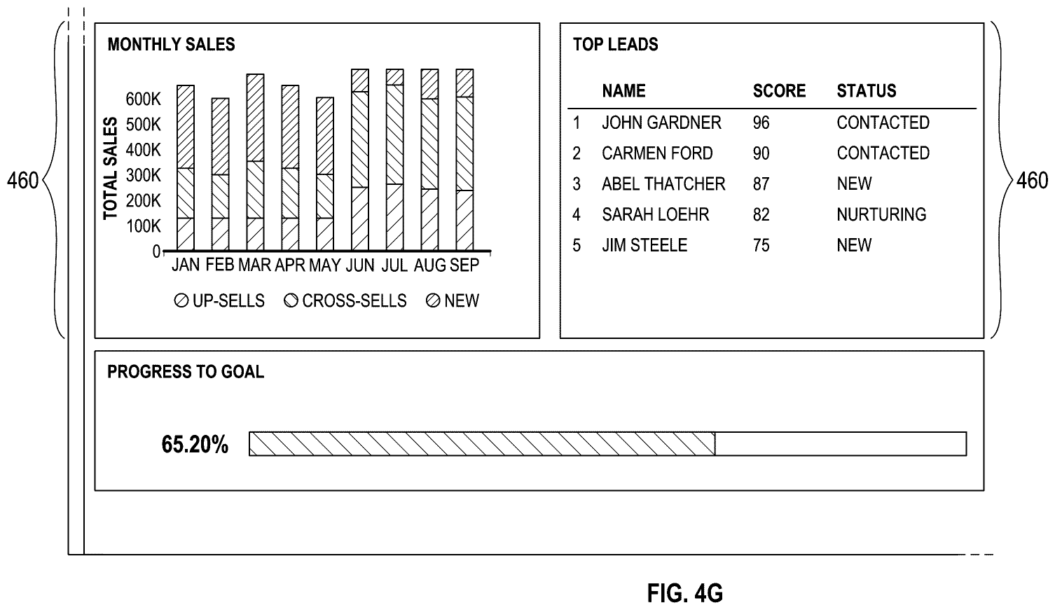

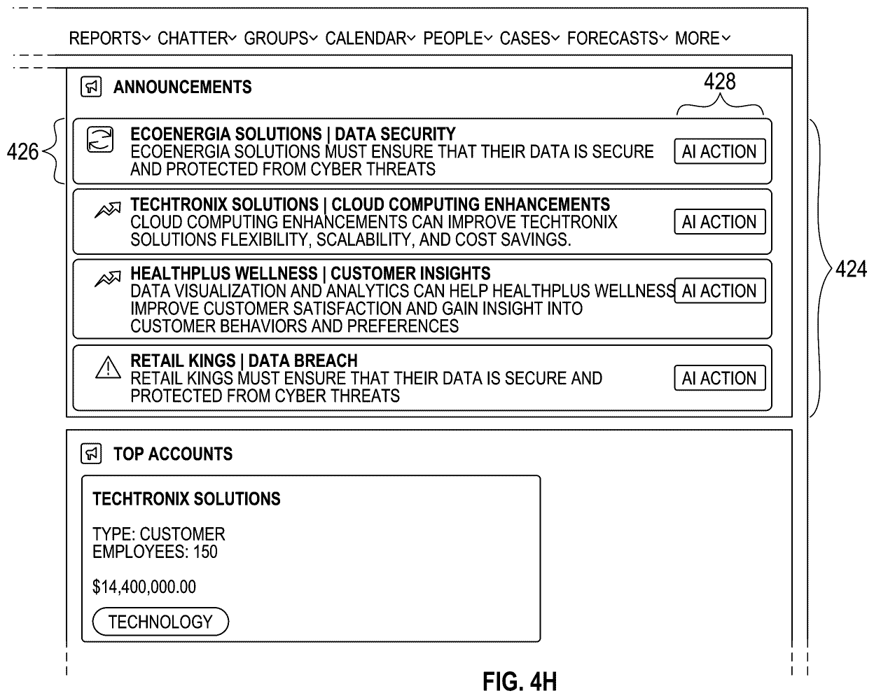

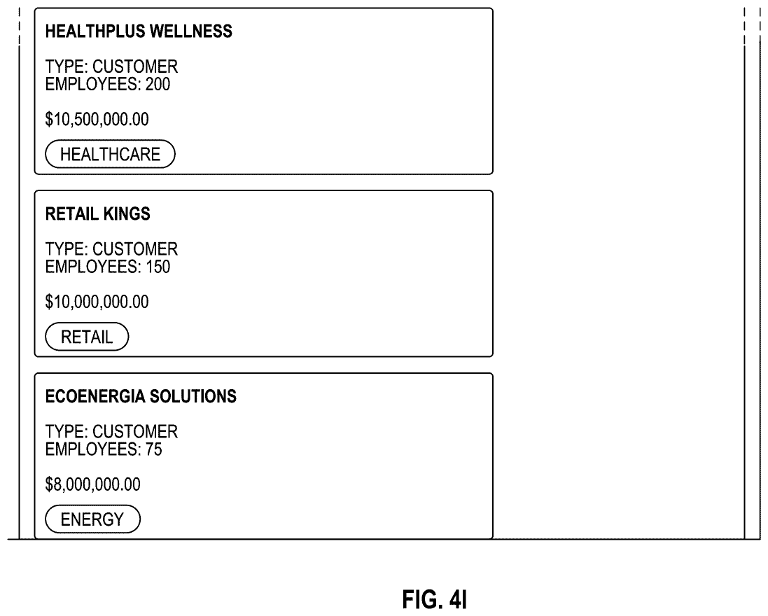

FIGS. 4A-4D illustrate an exemplary GUI 102 that may be displayed at step 308 of method 300. As shown, GUI 102 may include a section 424 that indicates opportunities for the user to interact with one or more entities. Section 424 may comprise a menu of recommended interactions corresponding to the recommended interactions indicated in the explainability data received from the machine learning models (see step 306 of method 300). For example, if the explainability data comprises a recommendation for interacting with a first entity (Entity A), a second entity (Entity B), and a third entity (Entity C), section 424 may include a menu item 426 corresponding to each recommended interaction. Each of these menu items 426 may comprise a human-readable description of the associated recommended interaction as well as one or more communication affordances 428, both of which may be generated based on the explainability data.

Each communication affordance 428 in a menu item 426 may be associated with a communication medium. A communication affordance 428 may comprise, e.g., a selectable icon that reflects the associated communication medium. When selected by the user, a communication affordance 428 may generate a communication data structure that is configured to facilitate the recommended interaction via the communication medium associated with the communication affordance.

In some embodiments, a menu item 426 comprises a communication affordance 428a that has email as its associated communication medium. As shown in FIG. 4B, when the user selects or otherwise interacts with communication affordance 428a, a data structure configured to facilitate the recommended interaction associated with the menu item that comprises communication affordance 428a (in this case, a recommended interaction with Entity A) may be generated. The generated data structure may comprise an email that can be sent from the user to a representative of Entity A. The email may include a summary of data associated with Entity A (e.g., data received at step 302 of method 300) that justifies or contextualizes the user's reasons for contacting Entity A. Additionally, the email may include a description of products or services that the user can offer to Entity A or a request from the user for goods or services (e.g., monetary donations) that Entity A can provide. The recipient of the email (e.g., the representative of Entity A) may be automatically populated based on the user's previous interactions with Entity A or based on stored data about the personnel (e.g., employees, executives, legal counsel, etc.) associated with Entity A.

When the user selects communication affordance 428a, the generated email may be displayed to the user, for example in a pop-up window 430. User controls 432 (e.g., buttons or widgets) that allow the user to, e.g., attach files to the email or send the email may be displayed along with the email. The text of the email may be provided in an interactive text field 434. The user may manually edit the text of the email using interactive text field 434.

In some embodiments, a user control 436 that enables the user to perform machine-learning-assisted revisions of the email is displayed along with the email. User control 436 may link the user to a large language model (LLM) chatbot 438, as shown in FIG. 4C. The LLM chatbot may use third-party large language models such as OpenAI's GPT-3 or GPT-4 LLMs or LLMs from Google's Gemini, PaLM, or LaMDA LLM families. Alternatively, the LLM chatbot may use a proprietary large language model developed by the user or by an organization to which the user belongs. The user may prompt the LLM chatbot to revise the email in various ways, for example by increasing or decreasing the formality of the language used in the email or by adding, removing, or rewording certain descriptions (e.g., descriptions of products or services offered by the user) that are included in the email. When the user is satisfied with the email, they may navigate back to, e.g., email pop-up window 430 shown in FIG. 4B, where they may use user controls 432 to send the email to the representative of Entity A.

In some embodiments, a menu item 426 comprises a communication affordance 428b that has a phone network or a video or voice call application (e.g., Microsoft Teams, Skype, Zoom, etc.) as its associated communication medium. As shown in FIG. 4D, when the user selects or otherwise interacts with communication affordance 428b, a data structure configured to facilitate the recommended interaction associated with the menu item that comprises communication affordance 428b (in this case, a recommended interaction with Entity A) may be generated. The generated data structure may comprise a script for a call between the user and a representative of Entity A. The script may include a summary of data associated with Entity A (e.g., data received at step 302 of method 300) that justifies or contextualizes the user's reasons for contacting Entity A. Additionally, the script may include a description of products or services that the user can offer to Entity A or a request from the user for goods or services (e.g., monetary donations) that Entity A can provide.

When the user selects communication affordance 428b, the generated script may be displayed to the user, for example in a pop-up window 440. The text of the script may be provided in an interactive text field 442 through which the user may manually edit the script. A user control 444 that enables the user to perform machine-learning-assisted revisions of the script may also be provided. Selecting user control 444 may link the user to a LLM chatbot such as LLM chatbot 438 shown in FIG. 4C. The user may prompt the LLM chatbot to revise the script in various ways, for example by increasing or decreasing the formality of the language used in the script or by adding, removing, or rewording certain descriptions (e.g., descriptions of products or services offered by the user) that are included in the script. When the user is satisfied with the script, they may navigate back to, e.g., script pop-up window 440.

A user control 446 that initiates a live call with the representative of Entity A may be displayed with the generated script. When the user selects user control 446, they may be linked to a video or voice call application (e.g., Microsoft Teams, Skype, Zoom, etc.), which may surface the representative's contact information and prompt the user to call the representative. If the user is viewing GUI 102 on a mobile device such a smartphone, then selecting user control 446 may link the user to telephone application that can make calls over a phone network.

If the user initiates a live call with the representative of Entity A, GUI 102 may automatically display the script for the user's reference when the call is in progress. The script may include predicted responses by the representative of Entity A to statements made by the user. In situations where the representative of Entity A may feasibly respond in multiple ways, the script may provide the user with options for replying to each possible response. The script may enable the user to efficiently prepare for a meeting with the representative of Entity A and may increase the clarity and effectiveness of the user's communication with the representative during the meeting.

In addition to, or as an alternative to, user control 446 for initiating live calls between the user and the representative of Entity A, a user control 448 for transmitting an automated voice message to the representative of Entity A may be displayed with the generated script. When the user selects user control 448, the generated script may be provided to a text-to-speech application to generate audio data comprising the script. The generated audio data may be transmitted to the representative of Entity A over, e.g., a phone network.

In some embodiments, a menu item 426 comprises a communication affordance 428c that has an electronic calendar as its associated communication medium. As shown in FIG. 4E, when the user selects or otherwise interacts with communication affordance 428c, a data structure configured to facilitate the recommended interaction associated with the menu item that comprises communication affordance 428c (in this case, a recommended interaction with Entity A) may be generated. The generated data structure may comprise an invitation for a call (e.g., over a voice or video call application) between the user and a representative of Entity A.

When the user selects communication affordance 428c, the generated calendar invitation may be displayed to the user, for example in a pop-up window 450. The generated calendar invitation may include a proposed date and time. The date and time may be automatically proposed based on the user's calendar and/or a calendar associated with the representative of Entity A. A first user control 452 and a second user control 454 that allow the user to manually change the date of the meeting or the time of the meeting, respectively may be provided along with the displayed invitation.

A text field 456 that includes a link to a voice or video call session on a voice or video call application may also be displayed. In some embodiments, text field 456 comprises a meeting agenda. The meeting agenda may be automatically or manually generated and may include a summary of data associated with Entity A (e.g., data received at step 302 of method 300) that justifies or contextualizes the user's reasons for scheduling the meeting with the representative of Entity A. Additionally, the meeting agenda may include a list of products or services that the user can offer to Entity A or a request from the user for goods or services (e.g., monetary donations) that Entity A can provide.

When the user is satisfied with the date, time, and agenda of the meeting, the user may transmit the meeting invitation to the representative of entity A (e.g., via email) using a user control 458. In some embodiments, transmitting the invitation may automatically populate an electronic calendar belonging to the user (e.g., a Microsoft Outlook calendar) and/or a calendar belonging to the representative of Entity A.

In addition to section 424, GUI 102 may provide various data visualization fields, including, e.g., a data visualization field 460 that provides plots or graphics generated based on the entity data ingested in step 302 and an interaction outcome visualization field 462 that provides plots or graphics based on user feedback about the recommended interactions. In some embodiments, GUI 102 can provide a periodically updated news feed 464 that links to relevant news reports associated with the one or more entities.

FIGS. 4F-4I show various portions of an example implementation of GUI 102. Specifically, FIG. 4F shows the upper-left portion of the example implementation of GUI 102, FIG. 4G shows the lower-left portion of the example implementation of GUI 102, FIG. 4H shows the upper-right portion of the example implementation of GUI 102, and FIG. 4I shows the lower-right portion of the example implementation of GUI 102. A user may navigate from the upper-left portion of the GUI (FIG. 4F) to the lower-left portion of the GUI (FIG. 4G) by scrolling down (e.g., using a scrollbar on the GUI). The user may navigate from the upper-left portion of the GUI (FIG. 4F) to the upper-right portion of the GUI (FIG. 4H) by scrolling to the right. The user may navigate from the upper-right portion of the GUI (FIG. 4H) to the lower-right portion of the GUI (FIG. 4I) by scrolling down. In some embodiments, the upper-left, upper-right, lower-left, and lower-right portions may be displayed simultaneously to the user (e.g., may be fit within the same view screen). As shown, the various portions of the example implementation of GUI 102 include an example section 424, example data visualization fields 460, and an example interaction outcome visualization field 462 is shown in FIG. 4F. In this example, GUI 102 is a dashboard for a salesperson.

Returning to FIG. 3, after the GUI for facilitating interactions with the one or more entities (e.g., GUI 102) is displayed (step 308), a user selection of a communication affordance provided by the GUI may be received (step 310). As described, when the user selects a communication affordance (e.g., any of communication affordances 428 shown in FIGS. 4A-4B and 4D-4E), a data structure configured to facilitate the recommended interaction via a communication medium may be generated. The data structure may comprise an email, a script for a call, a calendar invitation, or any other suitable data structure for initiating contact with the entity associated with the selected communication affordance via any suitable communication medium.

The user may use the generated data structure to initiate an interaction with the entity (step 312). After the interaction has concluded, user feedback about an outcome of the interaction may be received (step 314). If, for example, the user is a salesperson, and the interaction involved an attempt to sell a product or service to an entity, the user feedback may indicate whether or not the entity opted to purchase the product or service, the extent to which the user had to modify a communication data structure in order to make the sale, or amount of profit that the user made off of the sale. The GUI may prompt the user to provide their feedback, for example by displaying a text field where the user can provide a text description of their interaction with the entity or by displaying a widget with a survey that allows the user to input their opinions about the success of the interaction with the entity.

The user's feedback may be processed (e.g., by extracting keywords from the user's feedback that characterize the outcome of the interaction using a text analyzer such as a natural language processor) and provided to reinforcement learning model(s), which may use the feedback to improve the one or more machine learning models that provide the explainability data (step 316). The reinforcement learning model(s) may improve a machine learning model by updating a training data set associated with the machine learning model and re-training the machine learning model using the updated training set, updating how data is input into the model or how the model is prompted, or combinations thereof. In some embodiments, each machine learning model has a built-in reinforcement learning process—that is, each machine learning model may be configured to improve its performance based on user feedback. In other embodiments, a reinforcement learning model may be a separate analytic model (e.g., a separate machine learning model) that is configured to interface with one or more of the machine learning models. The improved machine learning models may be used in subsequent iterations of method 300.

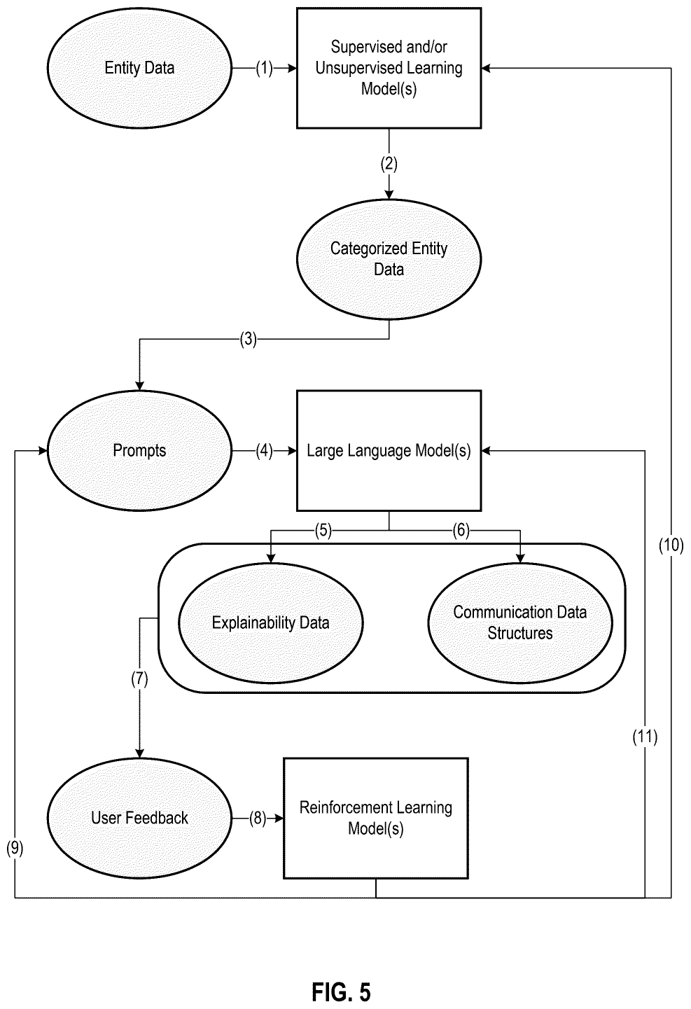

As described, machine learning techniques can be leveraged at a variety of stages of method 300. FIG. 5 provides a schematic of various machine learning models that may be used to generate and display a GUI for facilitating interactions with one or more entities, including example inputs and outputs to each model.

As shown, data associated with the one or more entities (e.g., data received in step 302 of method 300) may be provided to one or more supervised and/or unsupervised learning models (e.g., one or more neural networks), as indicated by arrow (1) in FIG. 5. The one or more supervised and/or unsupervised learning models output a data structure comprising categorized entity data (arrow (2) in FIG. 5). In this data structure, the received data associated with each entity may be classified according to one or more predefined interaction scenarios. The predefined interaction scenarios may vary based on the user and the entities. If, for example, the user is a salesperson and the entities are clients of the user, then the predefined interaction scenarios may include scenarios for each distinct product or service that the user offers for sale.

After the received data has been categorized, the categorized entity data structure may be used to generate one or more prompts for one or more large language models (arrow (3) in FIG. 5). In some embodiments, the prompts are generated using one or more predetermined prompt templates, which may be stored by the computer system. In some embodiments, the prompts may be generated using a machine learning model that has been trained to engineer prompts for a large language model based on the categorized entity data structure. The generated prompts may be input into the large language model(s) (arrow (4) in FIG. 5) to cause the large language model(s) to generate explainability data comprising recommendations for interacting with the one or more entities (arrow (5) in FIG. 5). The prompts may also cause the large language model(s) to output one or more communication data structures (e.g., emails, call scripts, etc.), possibly in response to a user selection of a communication affordance displayed on the GUI (arrow (6) in FIG. 5)). The large language model(s) may comprise third-party LLMs (e.g., OpenAI's GPT-3 or GPT-4 LLMs or LLMs from Google's Gemini, PaLM, or LaMDA LLM families) or a proprietary large language model developed by the user or by an organization to which the user belongs.

Provided below are example prompts corresponding to various interaction scenarios that a salesperson at a software service provider company may encounter:
(i) Scenario: Upsell Opportunities—“As a Software Service Provider Company. Company details {{companyDetails}}. {{accountName}} is my client. What minimum 3 offers can I offer {{accountName}} based on latest {{accountName}} news. Describe opportunity and it\'s relevance to {{accountName}}. Account details:{{accountDetails}}. Region details:{{regionDetails}}. Response must be formatted in the following JSON schema {\‘upsellOpportunities\’:[{\‘opportunity\’:value,\‘description\’:value}}]}”
(ii) Scenario: Risk Assessment—“As a Software Service Provider Company. Company details {{companyDetails}}. {{accuntName}} is my client. What minimum 3 offers can I offer {{accountName}} based on latest {{accountName}} news. Describe opportunity and it\'s relevance to {{accountName}}. Account details:{{accountDetails}}. Region details:{{regionDetails}}. Response must be formatted in the following JSON schema {\‘upsellOpportunities\’:[{\‘opportunity\’:value,\‘description\’:value}}]}.”
(iii) Scenario: Conversational Insights: “Give Sales Insight analysis, the Pricing Mentioned, Products Mentioned, Customer Demands, Challenges in deal, Trending things discussed, Question, Objections On Budget, Objections On Authority on the following conversation. Also suggest what should be the next best steps for salesman to convince the customer and make a deal. Response must be formatted the following JSON schema {\‘NextSteps\’:[ ],\‘ProductsMentioned\’:[ ],\‘PricingMentioned\’:[ ],\‘CustomerDemands\’:[ ],\‘Challenges\’:[ ],\‘Trending\’,[ ],\‘Questions\’:[ ],\‘ObjectionBudget\’:[ ],\‘ObjectionAuthority\’:[ ]}. Conversation—{{conversation}}”
(iv) Scenario: Top Announcements: “As a Sales Representative for Software Service Provider Company. My company details {{companyDetails}}. {{clientList}} are my clients. Suggest 1 upsell, cross-sell opportunities for Software service provider company with {{clientList}} based on latest news. Also tell any potential risk with clients {{clientList}}. Give the priority for upsell, crosssell and risk. Format response in JSON. Response must be formatted the following JSON schema {\‘Clients\’:[{\‘Name\’:value, \‘UpsellOpportunities\’:[{\‘Opportunity\’:value,\‘Description\’:value,\‘Priority\’:value}], \‘CrosssellOpportunities\’:[{\‘Opportunity\’:value,\‘Description\’:value,\‘Priority\’:value}], \‘Risks\’:[{\‘Risk\’:value,\‘Description\’:value,\‘Priority\’:value}]}]}”
   In these prompts, the field “{{companyDetails}} may include an overview of the user's company, an industry focus of the company, current company products, current AI initiatives of the company, or goals and objectives of the company. The field “{{accountDetails}}” may include an overview of a client account, preferences of the client account, a current status of the client account, security measures associated with the client account, or future plans associated with the client account.

The explainability data and the communication data structures may be made available to the user via the GUI (arrow (7) in FIG. 5). After the user, e.g., uses a communication data structure to initiate a recommended interaction based on information contained in the explainability data, the user may input feedback about an outcome of the interaction to one or more reinforcement learning models (arrow (8) in FIG. 5). The reinforcement learning models may update features of the prompts provided to the large language models (arrow (9) in FIG. 5), parameters of the supervised and/or unsupervised learning models used to categorize received entity data (arrow (10) in FIG. 5), parameters of the large language models (arrow (11) in FIG. 5), or combinations thereof.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

As used herein, the singular forms “a”, “an”, and “the” include the plural reference unless the context clearly dictates otherwise. Reference to “about” a value or parameter or “approximately” a value or parameter herein includes (and describes) variations that are directed to that value or parameter per se. For example, description referring to “about X” includes description of “X”. It is understood that aspects and variations of the invention described herein include “consisting of” and/or “consisting essentially of” aspects and variations.

When a range of values or values is provided, it is to be understood that each intervening value between the upper and lower limit of that range, and any other stated or intervening value in that stated range, is encompassed within the scope of the present disclosure. Where the stated range includes upper or lower limits, ranges excluding either of those included limits are also included in the present disclosure.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

Any of the systems, methods, techniques, and/or features disclosed herein may be combined, in whole or in part, with any other systems, methods, techniques, and/or features disclosed herein.

1. A method for displaying a graphical user interface (GUI) for facilitating interactions with one or more entities, the method comprising:
receiving data associated with the one or more entities from one or more data sources;
providing the data associated with the one or more entities to one or more machine learning models;
receiving explainability data from the one or more machine learning models, wherein the explainability data indicates one or more recommendations for interacting with the one or more entities; and
displaying the GUI for facilitating interactions with the one or more entities, wherein the GUI comprises one or more communication affordances generated using the explainability data, wherein a user selection of a communication affordance generates a communication data structure configured to facilitate a recommended interaction of the one or more recommended interactions via a communication medium.

2. The method of claim 1, wherein providing the data associated with the one or more entities to the one or more machine learning models comprises:
categorizing the data associated with the one or more entities according to one or more predefined interaction scenarios using a first machine learning model; and
generating one or more prompts for a large language model based on categorization of the data associated with the one or more entities.

3. The method of claim 2, wherein the one or more prompts are configured to cause the large language model to output the explainability data.

4. The method of claim 1, further comprising:
receiving a user selection of a communication affordance of the one or more communication affordances.

5. The method of claim 4, wherein the communication medium associated with the selected communication affordance is email.

6. The method of claim 5, further comprising:
in response to the user selection of the communication affordance, generating a communication data structure comprising an email to be sent to a representative of the entity associated with the selected communication affordance.

7. The method of claim 5, further comprising:
sending the email to the representative of the entity associated with the selected communication affordance.

8. The method of claim 4, wherein the communication medium associated with the selected communication affordance is a video or voice call application or a phone network.

9. The method of claim 8, further comprising:
in response to the user selection of the communication affordance, generating a communication data structure comprising a script for a call with a representative of the entity associated with the selected communication affordance.

10. The method of claim 9, further comprising:
contacting the representative of the entity associated with the selected communication affordance using the video or voice call application or the phone network.

11. The method of claim 10, further comprising:
displaying the script for the call on the GUI while the call is in progress.

12. The method of claim 10, further comprising:
providing the script to a text-to-speech application;
generating audio data comprising the script using the text-to-speech application; and
transmitting the audio data to the representative of the entity while the call is in progress.

13. The method of claim 8, further comprising:
in response to the user selection of the communication affordance, generating a communication data structure comprising an invitation for a call with a representative of the entity associated with the selected communication affordance.

14. The method of claim 13, further comprising:
populating an electronic calendar associated with the representative of the entity with the invitation.

15. The method of claim 1, further comprising:
receiving user feedback associated with a communication affordance of the one or more communication affordances, wherein the user feedback indicates an outcome of interacting with an entity of the one or more entities according to the recommended interaction associated with the communication affordance.

16. The method of claim 15, further comprising:
providing the user feedback to a reinforcement learning model; and
receiving updated explainability data indicating an improved recommendation for interacting with the entity.

17. The method of claim 1, wherein the one or more data sources comprises a server storing historical interaction data associated with at least one of the one or more entities.

18. The method of claim 1, wherein the one or more data sources comprises one or more news reports about at least one of the one or more entities.

19. A system for displaying a graphical user interface (GUI) for facilitating interactions with one or more entities, the system comprising one or more processors configured to:
receive data associated with the one or more entities from one or more data sources;
provide the data associated with the one or more entities to one or more machine learning models;
receive explainability data from the one or more machine learning models, wherein the explainability data indicates one or more recommendations for interacting with at least one of the one or more entities; and
display the GUI for facilitating interactions with the one or more entities, wherein the GUI comprises one or more communication affordances generated using the explainability data, wherein a user selection of a communication affordance generates a communication data structure configured to facilitate a recommended interaction of the one or more recommended interactions via a communication medium.

20. A non-transitory computer readable storage medium comprising instructions for displaying a graphical user interface (GUI) for facilitating interactions with one or more entities that, when executed by one or more processors of a computer system, cause the computer system to:
receive data associated with the one or more entities from one or more data sources;
provide the data associated with the one or more entities to one or more machine learning models;
receive explainability data from the one or more machine learning models, wherein the explainability data indicates one or more recommendations for interacting with at least one of the one or more entities; and
display the GUI for facilitating interactions with the one or more entities, wherein the GUI comprises one or more communication affordances generated using the explainability data, wherein a user selection of a communication affordance generates a communication data structure configured to facilitate a recommended interaction of the one or more recommended interactions via a communication medium.
